(19) United States
(12) Patent Application Publication
(10) Pub. No.: US 2019/0381757 A1
(43) Pub. Date: Dec. 19, 2019

(54) ONE-WAY PERMEABLE MEMBRANE WITH PROTECTIVE BARRIER AND METHOD OF ITS MANUFACTURE

(71) Applicants: Michal Sorm, 164 00 Praha 6 (CZ); Daniel Matak, 440 01 Louny (CZ)

(72) Inventor: Michal SORM, Praha (CZ)

(73) Assignee: Daniel Matak, 440 01 Loony (CZ)

(21) Appl. No.: 16/488,130

(22) PCT Filed: Feb. 22, 2018
(86) PCT No.: PCT/IB2018/051116

§ 371 Date: Aug. 22, 2019

(30) Foreign Application Priority Data
Feb. 23, 2017 (CZ) 2017-101
Sep. 26, 2017 (CZ) 2017-587

(51) Int. Cl. B32B 3/16; A43B 17/00; A43B 17/08; A43B 7/12

(52) U.S. Cl. CPC B32B 3/16; A43B 7/125; A43B 17/08; A43B 17/006

(57) ABSTRACT

The name of the invention: One-way membrane with a barrier protection, which ensures the function of permeability even in the case of contradirectional mechanical pressure, and the method of its manufacture. The invention relates to a single-layer or multilayer membrane (1) with through apertures (2), whose face layer (1) is connected with thin flexible plastic or rubber segments (3) overlapping the apertures (2) and allowing the air or fluid to flow only in the direction from the underside layer (12) of the membrane (1) to the face layer (11) of the membrane (1), as check valves/flaps in the number of up to 30 pieces per 1 cm². It further relates to the method of manufacturing the membrane (1).

### FIELD OF THE INVENTION

The invention relates to a one-way permeable membrane with many small apertures, overlaid with miniature elastic segments with a function of check valves or flaps, with barrier protection against mechanical loading directed against the movement of valves or flaps, and its method of manufacture. Miniaturization of the segments/flaps and barrier protection of segments allows the membrane to be used even under mechanical loads from any side without loss of functionality. For example, this feature can be used for forced ventilation of seats in the automotive and furniture industry or shoe inserts in the footwear industry, or replacement of classic large flaps in air conditioning and hydraulics.

### BACKGROUND OF THE INVENTION

In the technical practice, the check valve or flap is used as the simplest control element from time immemorial. It is especially used in hydraulic and air conditioning systems. In these areas of application, even very simple structures can be used, such as airtight fabric, leather or thin sheet freely overlapping the apertures, with the axle of fixing such a flap being also a rotation axis. The following applies to these structures: the larger the flap, the greater the clearance for the flap movement during its opening. When there is a need for very small space for the flap movement as well as high permeability, the solution is to use a large number of miniature flaps, e.g. sized about 1 to 3 mm², instead of one larger flap. However, in the case of such miniaturization and a large number of flaps/valves on a small area, there is a problem of how to manufacture the miniature flaps and fix them in the given place with the desired precision. In practice, these requirements potentially exist, e.g. for the manufacture of ventilated insoles, as solved by U.S. Pat. No. 4,888,887 A, according to which the top sheet of the insole is provided with apertures covered with check flaps, under which the insole has apertures with free space for deflection of the flap. Apparently, this solution has not been successful due to its complexity regarding the way of fixing the flaps above the apertures in the insole into which the flaps open. There is another known solution according to patent EP 1776883 A2, which consists of two mutually movable membranes with apertures or protrusions where the mutual position of the membranes regulates the permeability of the whole membrane system. This solution also does not meet the requirement for one-way permeability of the membrane in the conditions of shoes or seating surfaces because its disadvantage is the need for mutual movement of the membranes and its complexity.

So far, in the technical practice of textile, furniture, footwear and air-conditioning industry, there has been no simple possibility to modify the fabric or foil so that it is permeable to liquid or gaseous media only in one direction also during mechanical load directed against the movement of the flaps with flaps being mechanically protected against mechanical wear.

The present invention aims to overcome the above-mentioned disadvantages by obtaining a one-way permeable membrane with miniature segments/flaps, with barrier protection of these segments, allowing the membrane to be used without loss of functionality even when subjected to mechanical loading from any side. In addition, it aims to ensure that the segments, by virtue of their small size and higher elasticity, can be located over the entire area of insoles or seats without any negative effect on the comfort of treading or seating surfaces, or can replace the conventional check valves by their large number, with the advantage of easier manufacture and assembly while having minimal demands on the structure depth.

The invention further aims to provide a method of manufacturing the membrane with the said properties through a simple, inexpensive and standardized technology, and its use in the footwear industry for the manufacture of insoles with the function of an air pump during the tread and subsequent relieving.

### SUMMARY OF THE INVENTION

The above-mentioned advantages and determined aim are met by a one-way permeable membrane according to the pre-characterising portion of claim 1, whose essence consists in in the fact that the single-layer or multilayer membrane comprises a plurality of small apertures or joints with a surface area of about 4 mm², which are overlapped from the face of the membrane with fixed segments of a thin and flexible plastic/rubber material, firmly attached to the membrane only at the defined connecting parts of the segments so that the unattached working part of the segments is above the area of the apertures with the environment and can partially lift up by flexible stretching or tilting at elevated pressure of liquid or gaseous media from the underside of the membrane to allow air to flow from the underside of the membrane to the face of the membrane, similarly to check valves/flaps. In order to prevent any obstruction to the movement of flaps by the area mechanical counter-pressure, e.g. the surface of the shoe insole during the tread, the height of the spacing barrier is such that it provides a clearance for the valve or flap opening. At the same time, the spacing barrier protects the flap surface from mechanical wear. Conversely, at increased media pressure from the face of the membrane, the segments are in their initial position and do not allow the media to flow. When the plastics are printed or laminated in layers, it is common and usually needed to bond individual layers firmly together. When using the printing technology for printing and curing, in order to ensure that the working part of the segments is free, i.e. unattached to the face layer of the membrane, a partial separation layer is printed on the face of the membrane before the segments are printed, overlying the apertures in the membrane and the adjacent area on which the working parts of the segments will fit. This separation layer, which prevents the attachment of the face layer of the membrane to the working parts of the segments, will be removed or released in a suitable manner after the end of the production/production cycle, e.g. by spraying/dissolving or at least by partial evaporating, while the connecting part of the segments will firmly connect to the face of the membrane in accordance with the standard laminating or printing process. Similarly, it can also be used for laminating or combining printing and lamination.

When using the printing technology, another possibility is the use of mutually non-adhesive materials of the segments and the membrane facing layer, which do not bond even after curing and can be easily separated. However, in order to properly anchor the segments on the face layer, they are bonded only at the connecting parts of the segments by means of a printed partial bonding layer of material adhesive to both the subsequently printed segments and to the face layer of the membrane, an adhesive bridge, or mechanically by means of printed spacing barriers of material adhesive at least to the face layer of the membrane. The working part of the segments will remain naturally free. The membrane with through apertures can also be printed from a suitable material on a work-bench with Teflon or other non-adhesive/non-adherent finish before segments are printed, or it can be obtained in the market. Because of the miniature size of the printed segments, these are predominantly functional even at mechanical loads, e.g. during the tread when walking, if spacing barriers are printed or glued around the printed segments, reaching a height that is at least twice greater than the thickness of the segment.

Another possibility of the production method is laminating, gluing or high-frequency welding of individual components of the one-way membrane to the face layer of the membrane. Individual components can also be obtained by printing technology, casting or punching plotters, etc.

Preferably, the through apertures of the membrane are overlapped by printed thin segments of a flexible material from the face side at a given location. Thanks to the printing technology, this arrangement allows for sufficient miniaturization and precise alignment of the segments above the apertures.

Preferably, the printed segments are connected to the membrane only by their connecting parts whereas the working part of the segments above the apertures and their close vicinity is not connected. With an optimum size of the segments of about 1 to 4 mm², the membrane can be easily manufactured using standard printing technologies while retaining the desired properties. The advantage of this arrangement is that the segments printed in situ allow for sufficient accuracy to ensure functionality of the check valves/flaps even at miniaturization.

Preferably, there are spacing barriers around working parts of the printed segments, attached individually or in groups, whose height is at least two times greater than the thickness of the segments. The advantage of this arrangement is that the segments are protected against mechanical wear and are fully functional even under load forces acting against the direction of the lifting of the working parts of the segments.

For the aforementioned purposes, the one-way permeable membrane is preferably produced by the method of manufacture according to the second main claim 4, whose essence consists in the fact that the face of the membrane with through apertures is printed with a partial separation layer which covers the apertures in the membrane and the adjacent area against which the working part of the segments abuts. This separation layer will be removed or released upon completion of the membrane. Subsequently, segments of material adhesive to the face of the membrane are printed over the separation layer and the connecting parts of the segments are firmly connected to the membrane after drying, i.e. thermal curing. Printing of individual components is done using a standard printing technology allowing the application of individual layers of material in the thickness of 0.02 to 0.2 mm, e.g. screen printing, flexographic printing, offset printing, jet printing, etc. After removal or release of the separation layer, the working parts of the segments will be free and can function as check valves/flaps.

Preferably, prior to printing the segments of material non-adhesive to the material of the face of the membrane, the face is printed by a partial bonding layer, an adhesive bridge, in places which will be under the connecting part of the segments, which is adhesive to the material of segments and the face of the membrane. The advantage of this solution is that the printed segments will be attached to the membrane only at the point of connecting parts under which the bonding layer/adhesive bridge occurs whereas the working parts of segments will be free and will function as the valves/flaps without the need of printing the separation layer and its subsequent removal.

Preferably, after printing the segments of material which is non-adhesive to the material of the face of the membrane, the face of the membrane is printed with spacing barriers from the material adhesive to the face of the membrane so that a portion of the spacing barrier area is firmly connected to the face of the membrane, whereas other portion of the protective spacing barrier area overlaps connecting parts of the segments, thus anchoring them in the given position. The advantage of this solution is that the printed segments will be attached to the membrane only at the point of the connecting parts without the need of printing the bonding layer/adhesive bridge.

Preferably, when using segment materials which are not adhesive to the material on the face of the membrane but adhere to the material of the bonding layer, the work-bench with Teflon surface finish is used to first print the partial bonding layer forming a set of a plurality of individual separate squares/elements of such a size and location so that the subsequently printed membrane with through apertures partially overlaps them in the places of connecting apertures in the membrane, whereas the printed segments then overlap the through apertures in the membrane with their working part and, with their connecting parts they firmly connect through the connecting apertures with the squares/elements of the bonding layer after drying. The advantage of this solution is a stronger attachment of segments to the membrane.

Preferably, all the components of the one-way permeable membrane are created using a print technology in a sequence leading to the final product. The advantage of this process is the high accuracy of overlapping the apertures, complex shapes of the resulting product without the need for cutting and subsequent waste.

Preferably, one of the membrane layers is a woven fabric or finely perforated foil reinforced or unreinforced with textile fibres. This is particularly advantageous to obtain the resulting product in multi-metric roles.

Preferably, one of the membrane layers is a standardly made perforated foil, and the print or press technology is used to form a combined set of segments with a set of spacing barriers and then to combine these components into one whole by heat lamination, bonding or high frequency welding. The advantage of this process may be higher productivity and the possibility of using materials that are not capable of joint curing.

Preferably, individual components of the one-way permeable membrane are manufactured separately in specialized workplaces, e.g. using a cutting plotter, especially at higher thicknesses that are poorly printed, and subsequently combined into one whole by heat lamination, bonding or high frequency welding. The advantage of this procedure may be the higher productivity, the possibility of using materials that are not capable of joint curing and continuous production in long strips/rolls.

Preferably, the footwear insoles are made of a standard foam material, whereas their upper sides are fully or at least partially covered by the one-way permeable membrane ensuring that the air is pushed from the insole only in one direction during the tread and parallel deformation of the foam insole part. The advantage of this solution is the reduction in the amount of one-way permeable membrane.

Preferably, the footwear insoles are made of standard foam coated by the one-way permeable membrane from the top and bottom in the same direction of air permeability. This arrangement provides the function of the insole as an air pump that ensures that the air pushed away will not return into the insole during the tread and deformation of the foam insole part. The advantage of this solution is the higher efficiency of the insole as an air pump.

Preferably, the footwear insoles are made of standard foam whose top side in the region of the heel is coated by the one-way permeable membrane in the reversed orientation of the air permeability compared to the one-way permeable membrane placed on the top of the insole in the region of toes and metatarsus. The advantage of this solution is that the air can circulate during the tread and subsequent relieving between the heel part of the insole and the parts under the toes and metatarsus without the need to adjust the footwear.

### CLARIFICATION OF FIGURES IN DRAWINGS

FIG. 1a a detail of printed membrane with arc-shaped apertures

FIG. 1b a detail of a finely perforated membrane/conventional foil

FIG. 1c a detail of the printed segments on the face layer of the membrane

FIG. 2a detail of the partial proof of the separation layer on the face of the membrane

FIG. 2b a detail of the partial proof of the bonding layer adhesive bridges

FIG. 2c a detail of the partial proof of the of the separation layer on the perforated conventional foil

FIG. 3a a detail of the printed segments on the face layer of the membrane supported by the partial separation layer

FIG. 3b a detail of the printed segments on the face layer of the membrane supported by the partial bonding layer under the connecting parts of the segments

FIG. 3c a detail of the printed segments on the face layer of a membrane of the material non-adhesive to the face layer of the membrane

FIG. 3d a detail of printed segments on the face of a finely perforated membrane/conventional foil prior to the printing of spacing barriers

FIG. 3e a detail of an individual segment printed on the separation layer and the face of the membrane bounded by the spacing barrier cross-section

FIG. 4a a detail of the membrane with segments and barriers in the initial position

FIG. 4b a detail of the segments and spacing barriers printed on a conventional perforated foil

FIG. 4c a detail of the membrane with segments in the open position

FIG. 5a a detail of the partial bonding layer printed on a work-bench

FIG. 5b a detail of the membrane printed on a work-bench with protrusions

FIG. 5c a detail of the printed flaps connected through connecting apertures with the bonding layer

FIG. 6 a view of a ready-to-connect membrane lamination, bonding or welding, with connected segments of flaps and barriers

FIG. 7 a detail of the functional arrangement of the finished membrane in the form of an air pump

FIG. 8 a detail of the embodiment of an insole coated with the one-way permeable membrane only from the top side for a modified body of the shoe

FIG. 9 a detail of the embodiment of an insole coated on both sides with the one-way permeable membrane with the same orientation of permeability for a modified body of the shoe

FIG. 10 a detail of the embodiment of an insole coated with two separate portions of the one-way permeable membrane with a reverse orientation only from the top side

FIG. 11 a view of the bearing foil with grooves

### EXAMPLES OF THE INVENTION IMPLEMENTATION

Examples of embodiments and manufacturing methods, including examples of use in footwear.

### Exemplary Embodiment 1

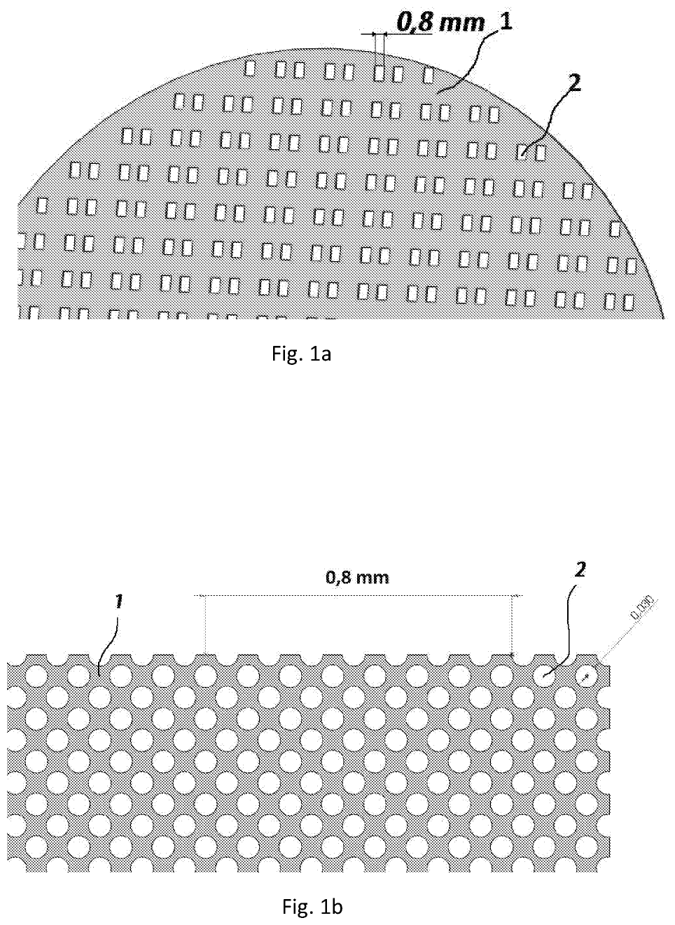

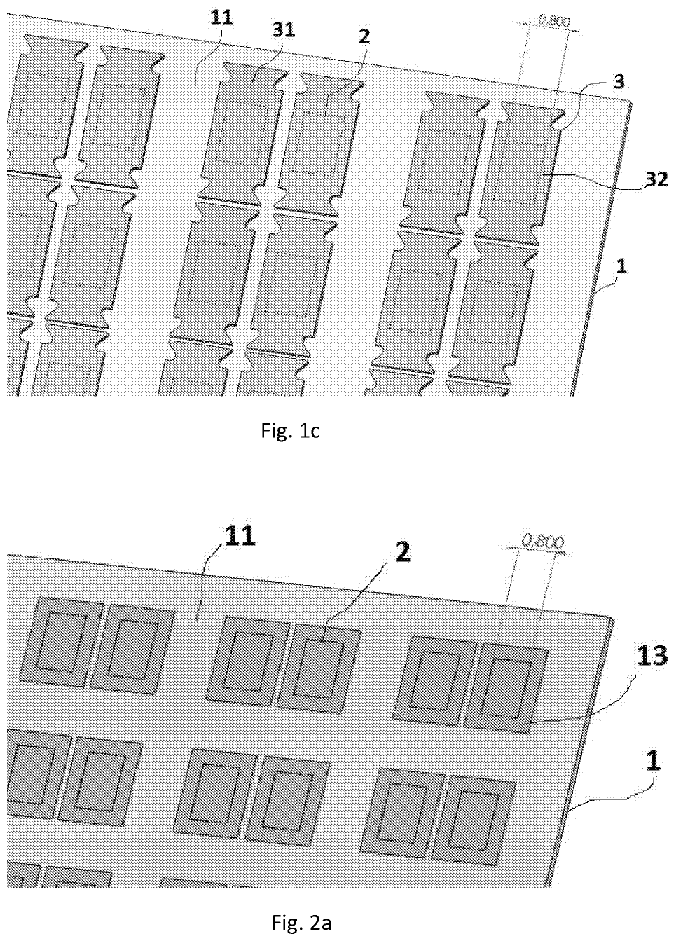

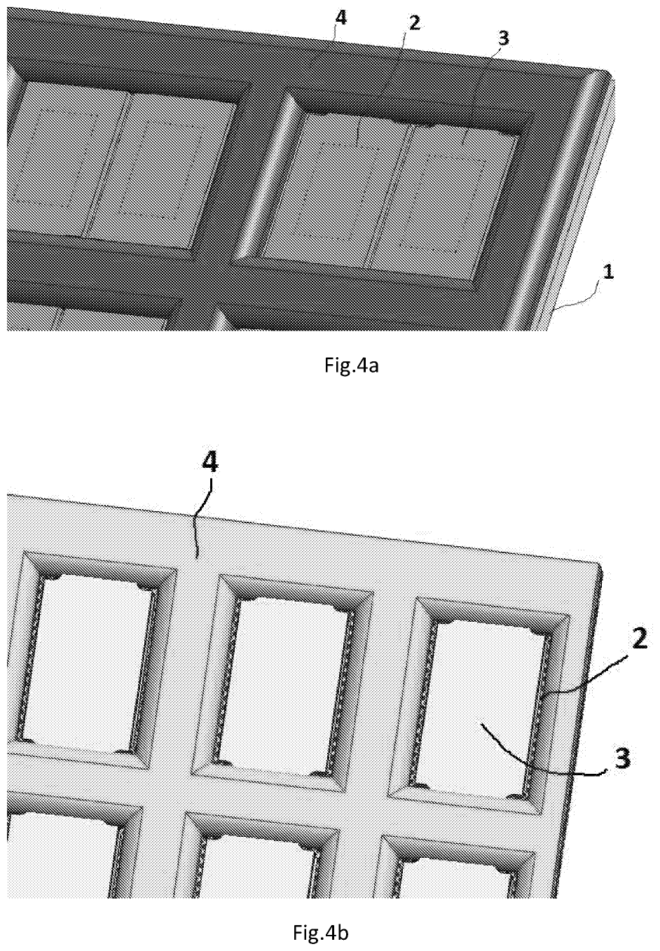

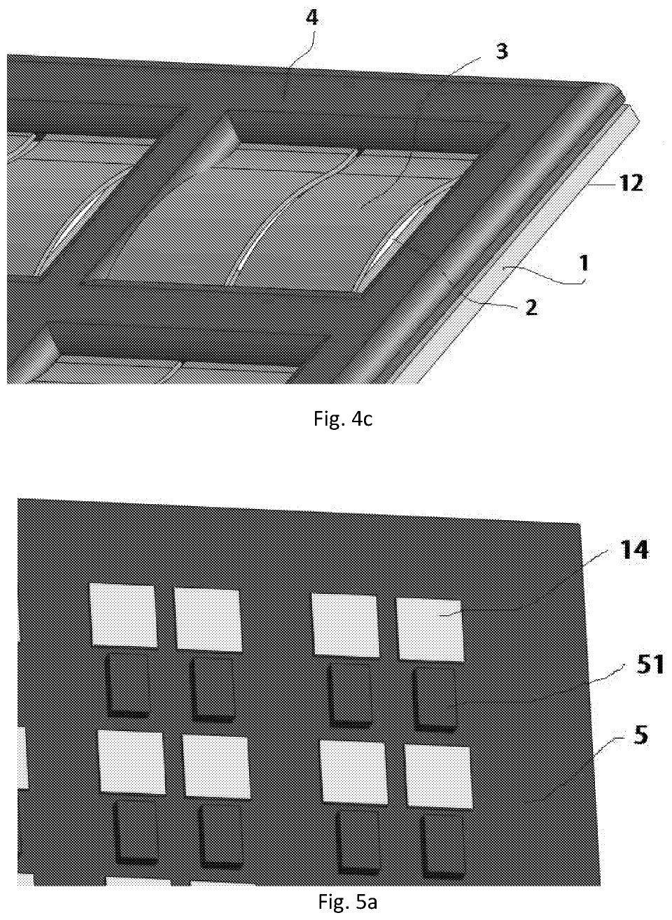

The basic element of the one-way permeable membrane is the membrane 1, approximately 0.2 mm thick, printed by a printing technology from a flexible plastic on a work-bench with Teflon or other non-adhesive/non-adherent treatment, with protrusions, with through apertures 2 sized approximately 0.8×1 mm as shown in FIG. 1a. These apertures 2 also using the printing technology, are overlapped with thin segments 3 printed from a flexible plastic, approximately 0.1 mm thick, which are or will be, depending on the manufacturing method, firmly connected to the face of the membrane 11 with their connecting part 31 and which completely overlaps the apertures 2 of the membrane 1 with their working part 32 not connected to the face of the membrane 11 and thus fulfil the function of the check valves/flaps as shown in FIG. 1c. The pairs of segments 3 are bounded by spacing barriers 4 made of tough plastic, about 0.2 mm high and about 0.5 to 1 mm wide, as seen in FIG. 4a. The spacing barriers 4 serve to protect the segments 3 from mechanical damage and also provide free space for the movement of the working part 32 of segments 3 as seen in FIG. 4c, or possibly anchor the segments in the given position according to the method of manufacture. These may be separate protrusions or joined profiles.

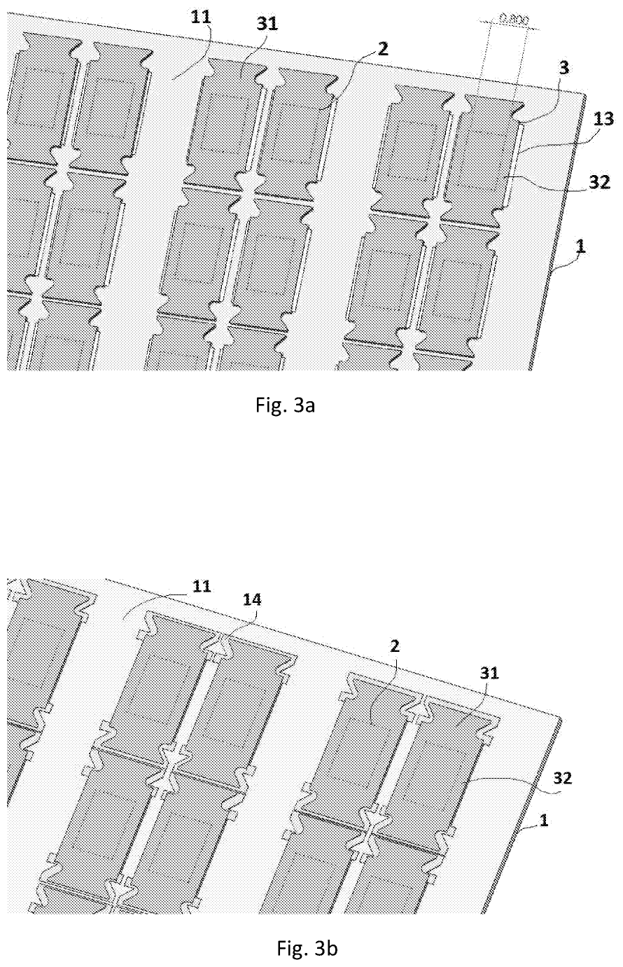

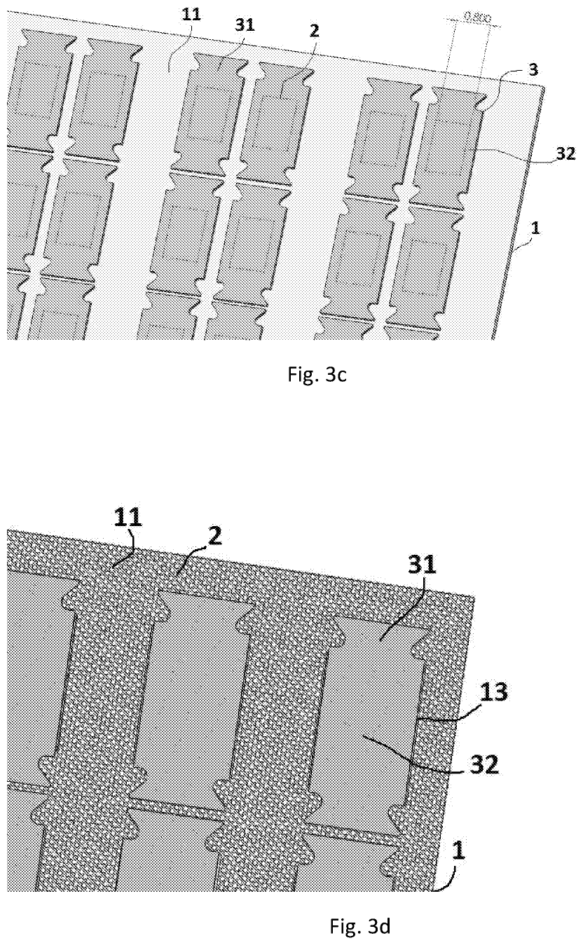

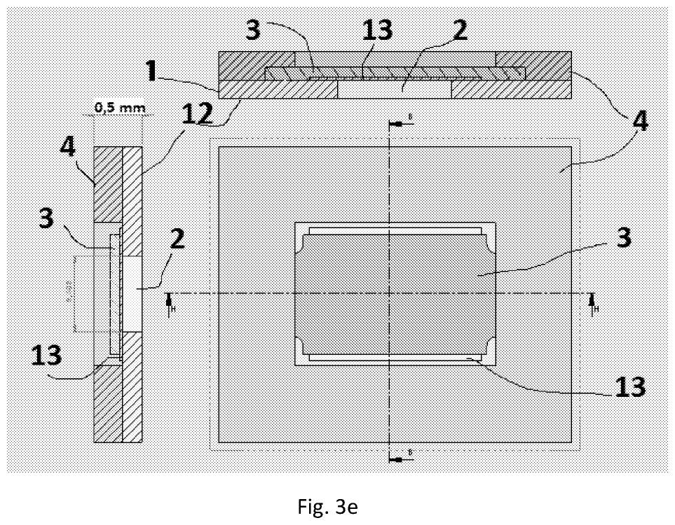

For an environment with a higher mechanical stress, the spacing barrier 4 is used for each segment 3 separately. See FIG. 3e.

### Exemplary Embodiment 2

In this exemplary embodiment, the change compared to the previous embodiment consists only in the fact that the membrane 1 with apertures 2 with an area of about 0.01 mm², shown in FIG. 1b, is not printed in situ by the printing technology but obtained as a commercially available perforated foil with the desired properties, e.g. from PVC. The detail of the final product is shown in FIG. 4b. The apertures 2 are covered by segments 3 and spacing barriers 4 at least for 90%. Individual components can be obtained by a printing technology or by pressing or cutting on plotter. Instead of the perforated foil, a permeable fabric can also be used.

### Method of Manufacture

For the manufacture of one-way permeable membrane, it is possible to use commercially available materials, such as printing emulsions from PVC/based on soft PVC (Plastizol), PUR/based on aromatic and aliphatic polyurethanes, PAK/based on polyacrylate dispersions, silicone emulsions (SXT ELASTI-WHITE 200 from the company PRINTOP), etc., as well as polyester or PVC perforated foils or permeable fabrics. The foils may be reinforced with textile fibres. Only the separation layer material is a suitable individually mixed emulsion, e.g. K₂CO₃(about 50%), glucose (about 25%) and water (about 25%), with a small addition of surfactant. However, it is possible to use many other removable mixtures based on dextrin, gum and volatile oils. Also, the material for the bonding layer/adhesive bridge is suitable to be prepared individually, e.g. from fluid rubber (about 50%) and silicone emulsion (about 50%). Due to the wide range of plastics with the required properties, namely flexibility, abrasion resistance, toughness, adhesion or non-adhesion mutual bonds, the above-mentioned materials are named as one of many. The work-benches of the printing machines may be equipped with a non-adhesive surface, or it is possible to use transfer paper for print transferring. Most of the materials used for printing require just slight drying between operations; the final drying/thermal curing is done only after the last printing. To accelerate the production cycle, materials with UV curing can be used.

### Production Method Example 1

On a standard screen printing machine, at least with four screens which are standardly prepared for individual graphic prints, with work-benches 5 with Teflon surface finish or with protrusions 51 equipped with a thermal drying tunnel with a set temperature of approx. 160° C., the following operations are carried out:

### Operation 1

Printing from screen 1, having a fibre diameter of about 200 μm, is done with the material consisting of the emulsion of PVC (about 65%) and terephthalate (35%), and the work-bench is used to print the desired shape of the membrane 1 in a circular shape, with a thickness of about 0.2 mm, with a pattern constituting a set of a plurality of small unprinted rectangles sized 0.8×1.2 mm, being future apertures 2 in the membrane 1. See FIG. 1a.

### Operation 2

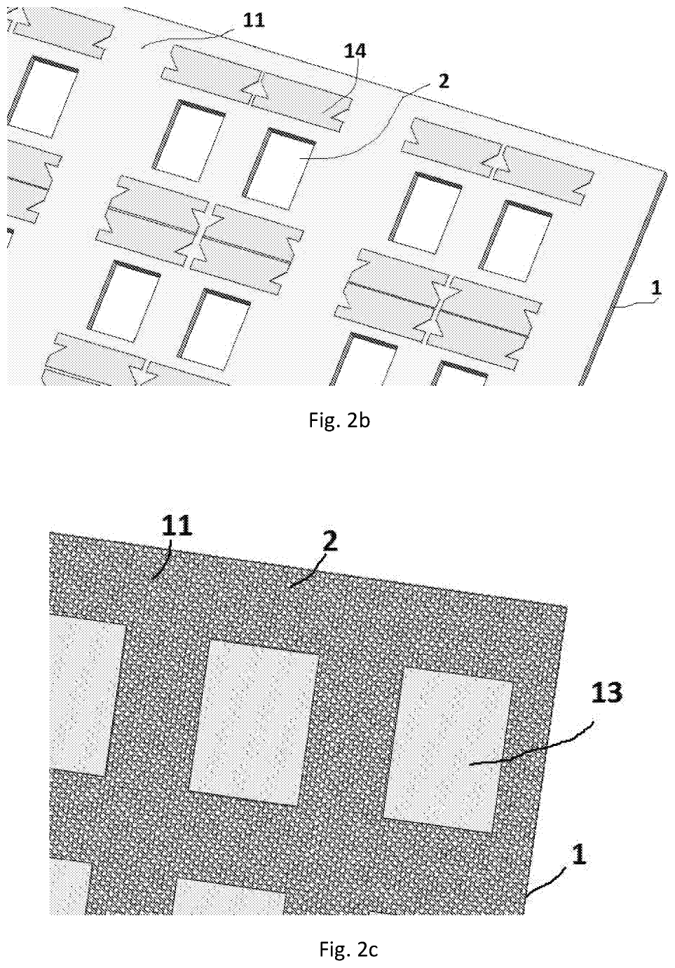

After drying, the work-bench with the printed membrane 1 is moved under the screen 2. Printing from screen 2, having a fibre diameter of about 50 μm, is done with the material for the separation layer 13, consisting of kaolin (about 10%), talc (about 30%), glucose (about 25%), water (about 35%) and a small addition of glycerine, and the partial separation layer 13 is printed on the face 11 of the membrane 1 overlaying the apertures 2 of the membrane 1 with a small overlap. See FIG. 2a.

### Operation 3

After drying, the work-bench with the printed membrane 1 is moved under the screen 3. Printing from screen 3, having a fibre diameter of 100 μm, is done with the material adhesive to the face 11 of the membrane 1 consisting of the emulsion of PVC (about 45%), terephthalate (about 10%) and fluid rubber (about 45%), and the segments 3 with a thickness of about 0.1 mm, are printed on the face 11 of the membrane 1, whereas their working part 32 is above the elements of the printed partial separation layer 13 and also above the apertures 2 in the membrane 1, and their connecting parts 31 are firmly connected to the face 11 of the membrane 1 after being dried. See FIG. 3a.

### Operation 4

After drying, the work-bench with the printed membrane (1) is moved under the screen 4. Printing from screen 4, having a fibre diameter of 200 μm, is done with the material adhesive at least to the face 11 of the membrane 1 consisting of the emulsion of PVC (about 65%) and terephthalate (about 35%), and the spacing barriers 4, with a height of about 0.2 to 0.3 mm, are printed on the face 11 of the membrane 1 whereas their area overlaps the connecting parts 31 of the segments 3 and the remaining area of the spacing barriers 4 is firmly connected to the face 11 of the membrane 1 after being dried. See FIG. 4a.

Operation 4 can be repeated in order to obtain a greater height of spacing barriers 4.

Upon completion of the printing operations and thermal drying/curing, the membrane is pulled down from the work-bench, the separation layer 13 is washed away, and the correct function of working parts of the segments 32 is tested by air pressure from the underside 12 of the membrane 1. See FIG. 4c.

If necessary, the individual printing operations can be repeated even in more working positions, i.e. the use of two or more screens, and the order of operations can also be reversed.

### Production Method Example 2

On a standard screen printing machine, at least with four screens which are standardly prepared for individual graphic prints, with work-benches with Teflon surface finish 5 or with protrusions 51 equipped with a thermal drying tunnel, the following operations are carried out:

### Operation 1

Printing from screen 1, having a fibre diameter of about 200 μm, is done with the material consisting of the emulsion of PVC (about 65%) and terephthalate (35%), and the work-bench is used to print the desired shape of the membrane 1 in a circular shape, with a thickness of about 0.2 mm, with a pattern constituting a set of a plurality of small unprinted rectangles sized 0.8×1.2 mm, being future apertures 2 in the membrane 1. See FIG. 1a.

### Operation 2

After drying, the work-bench with the printed membrane 1 is moved under the screen 2. Printing from screen 2, having a fibre diameter of about 50 μm, is done with the material for the bonding layer 14 consisting of fluid rubber (about 50%) and silicone emulsion (about 50%), which is adhesive to the face 11 of the membrane 1 and also to the material for printing the segments 3 whereas the partial bonding layer 14 is printed on the face 11 of the membrane 1 in locations intended for subsequent printing of the connecting parts 31 of the segments 3. See FIG. 2a.

### Operation 3

After drying, the work-bench with the printed membrane 1 is moved under the screen 3. Printing from screen 3, having a fibre diameter of 100 μm, is done with the material non-adhesive to the face 11 of the membrane 1, e.g. the emulsion of silicone mixtures SXT ELASTI-WHITE 200 from the company PRINTOP, and the segments 3 with a thickness of about 0.1 mm, are printed on the face 11 of the membrane 1 whereas their working part 32 is above the apertures 2 in the membrane land their connecting parts 31 after drying are firmly connected to the face 11 of the membrane 1 through the bonding layer 14/adhesive bridges, whereas the working part 32 of the segments 3 remains free even after drying. See FIG. 3a.

### Operation 4

After drying, the work-bench with the printed membrane 1 is moved under the screen 4. Printing from screen 4, having a fibre diameter of 200 μm, is done with the material consisting of the emulsion of PVC (about 65%) and terephthalate (about 35%), which is at least adhesive to the face 11 of the membrane 1 on which the spacing barriers 4 are printed, with a height of about 0.2 to 0.3 mm, whereas their area overlaps the connecting parts 31 of the segments 3 and the remaining area is firmly connected to the face 11 of the membrane 1 after being dried. See FIG. 4a.

Operation 4 can be repeated in order to obtain a greater height of spacing barriers 4.

If necessary, the individual printing operations can be repeated even in more working positions, i.e. the use of two or more screens, and the order of operations can also be reversed.

Upon completion of the printing operations, the membrane is pulled down from the work-bench.

### Production Method Example 3

On a standard screen printing machine, at least with three screens which are standardly prepared for individual graphic prints, with work-benches with Teflon surface finish 5 or with protrusions 51, equipped with a thermal drying tunnel, the following operations are carried out:

### Operation 1

Printing from screen 1, having a fibre diameter of about 200 μm, is done with the material consisting of the emulsion of PVC (about 65%) and terephthalate (35%), and the work-bench is used to print the desired shape of the membrane 1 in a circular shape, with a thickness of about 0.2 mm, with a pattern constituting a set of a plurality of small unprinted rectangles sized 0.8×1.2 mm, being future apertures 2 in the membrane 1. See FIG. 1a.

### Operation 2

After drying, the work-bench with the printed membrane 1 is moved under the screen 2. Printing from screen 2, having a fibre diameter of 100 μm, is done with the material non-adhesive to the face 11 of the membrane 1, e.g. the emulsion of silicone mixtures SXT ELASTI-WHITE 200 from the company PRINTOP, and the segments 3 with a thickness of about 0.1 mm, are printed on the face 11 of the membrane 1 whereas their working part 32 is above the apertures 2 in the membrane 1. After drying, the printed segments are not firmly connected to the face 11 of the membrane 1 because the materials used are not capable of mutual adhesion. See FIG. 3c.

### Operation 3

After drying, the work-bench with the printed membrane 1 is moved under the screen 3. Printing from screen 3, having a fibre diameter of 200 μm, is done with the material consisting of the emulsion of PVC (about 65%) and terephthalate (about 35%), which is at least adhesive to the face 11 of the membrane 1, and the spacing barriers 4, with a height of about 0.2 to 0.3 mm, are printed on the face 11 of the membrane 1 whereas their area overlaps the connecting parts 31 of the segments 3 and the remaining area is firmly connected to the face 11 of the membrane 1 after being dried. In this way, the connecting parts 31 of the segments 3 are anchored in the initial position to the face 11 of the membrane 1. See FIG. 4a.

Operation 3 can be repeated in order to obtain a greater height of spacing barriers 4.

If necessary, the individual printing operations can be repeated even in more working positions, i.e. the use of two or more screens, and the order of operations can also be reversed.

Upon completion of the printing operations, the membrane is pulled down from the work bench.

### Production Method Example 4

This embodiment uses a commercially available perforated PVC foil with a thickness of 0.2 mm, in a roll, with apertures sized about 0.06 mm in diameter, in the number of about 100 per 1 mm², which forms the membrane 1 with through apertures 2. This membrane is fed into a jet printing machine equipped at least with three consecutively arranged print heads fitted with nozzles preferably in a width corresponding to the fed membrane 1 and a control unit for processing digital data of the graphic master.

Printing head 1 at the first position is refilled with the material for the separation layer 13 consisting of kaolin (about 10%), talc (about 30%), glucose (about 25%), water (about 35%) and a small addition of glycerine, and according to the set program prints the pattern of the partial separation layer 13 on the face 11 of the membrane 1, with a thickness of about 0.05 mm. See FIG. 2c.

Printing head 2 at the second position is refilled with the material adhesive to the face 11 of the membrane 1 e.g. consisting of the emulsion of PVC (about 45%) and terephthalate (about 10%) and fluid rubber (about 45%), and according to the set program prints the pattern of the segments 3 on the face 11 of the membrane 1, with a thickness of about 0.1 mm, whose working part 32 is above the elements of the partial separation layer 13 and also above the apertures 2 in the membrane 1, and whose connecting parts 31 are firmly connected to the face 11 of the membrane 1 after being dried. See FIG. 3d.

Printing head 3 at the third position is refilled with the material adhesive at least to the face 11 of the membrane 1 e.g. consisting of the emulsion of PVC (about 65%) and terephthalate (about 35%), and on the membrane prints the spacing barriers 4 with a height of about 0.2 to 0.3 mm, whose area overlaps the connecting part 31 of the segments 3 and the remaining area is firmly connected to the face 11 of the membrane 1 after being dried. See FIG. 4b.

The printing machine is followed by a drying oven with a set temperature of about 160° C.; the individual components are dried and the separation layer 13 is subsequently removed by rinsing with pressure water.

When using a prefabricated perforated foil, a small portion of the apertures (up to 10%) located on the area between the edges of the segments 3 and the spacing barriers 4, remains uncovered and will allow the air to flow in both directions, which may be an advantage in some applications.

### Production Method Example 5

On a standard screen printing machine, at least with four screens which are standardly prepared for individual graphic prints, with work-benches with Teflon surface finish 5 or with protrusions 51 equipped with a thermal drying tunnel, the following operations are carried out:

### Operation 1

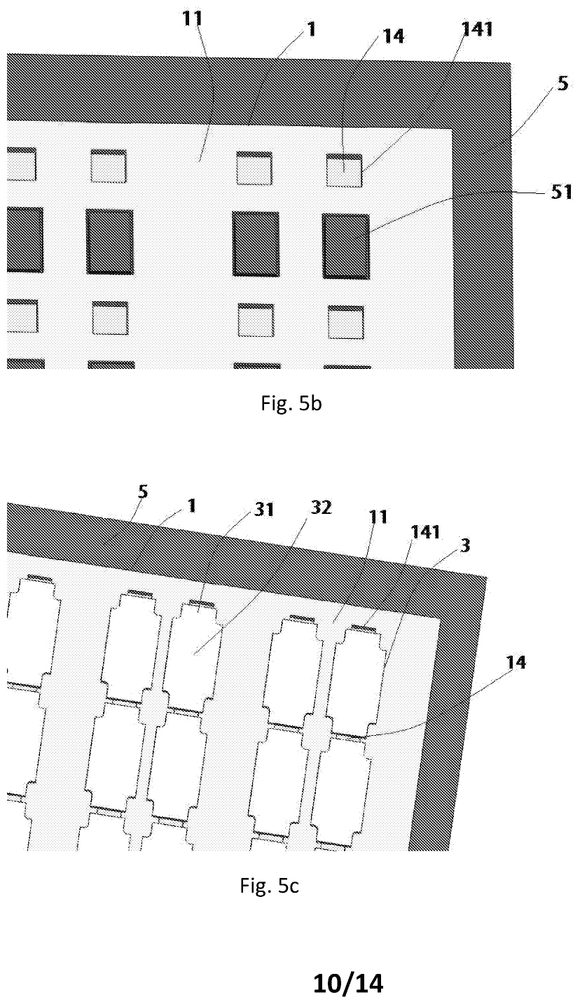

Printing from screen 1, having a fibre diameter of about 200 μm, is done with the material adhesive to the material for printing the segments 3 e.g. the emulsion of silicone mixtures SXT ELASTI-WHITE 200 from the company PRINTOP. The partial bonding layer 14 with the pattern comprising a set of a plurality of small printed squares sized 1 mm×1 mm, is printed on the locations intended for future subsequent printing of the connecting parts 31 of the segments 3. See FIG. 5a.

### Operation 2

After drying, the work-bench with the printed partial bonding layer 14 is moved under the screen 2. Printing from screen 2, having a fibre diameter of about 200 μm, is done with the material consisting of the emulsion of PVC (about 65%) and terephthalate (35%), and the work-bench is used to print the desired shape of the membrane 1, with a thickness of about 0.2 mm, with a pattern constituting a set of a plurality of small unprinted rectangles sized 0.8×1.2 mm, being future apertures 2 in the membrane 1, and a larger set of unprinted squares sized 0.7 mm ×0.7 mm, being future connecting apertures 141 centrally located above the elements of the partial layer 14. See FIG. 5b.

### Operation 3

After drying, the work-bench with the printed membrane 1 is moved under the screen 3. Printing from screen 3, having a fibre diameter of 100 μm, is done with the material non-adhesive to the face 11 of the membrane 1, e.g. the emulsion of silicone mixtures SXT ELASTI-WHITE 200 from the company PRINTOP, but adhesive to the partial layer 14. The segments 3, with a thickness of about 0.1 mm, are printed on the face 11 of the membrane 1 whereas their working part 32 is above the apertures 2 in the membrane 1 and their connecting parts 31 are above the connecting apertures 141, under which there are already printed squares of the partial layer 14 with which after drying/curing they will be firmly connected through the connecting apertures 141, whereas the working part 32 of the segments 3 will remain free even after drying. Due to the fact that the individual squares of the partial bonding layer 14 are larger than the connecting apertures 141 in the membrane 1 the connecting parts 31 of the segments 3 are firmly attached to the membrane 1. See FIG. 5c.

### Operation 4

After drying, the work-bench with the printed membrane 1 is moved under the screen 4. Printing from screen 4, having a fibre diameter of 200 μm, is done with the material consisting of the emulsion of PVC (about 65%) and terephthalate (about 35%), which is at least adhesive to the face 11 of the membrane 1 on which the spacing barriers 4 are printed, with a height of about 0.2 to 0.3 mm, whereas their area overlaps the connecting parts 31 of the segments 3 and the remaining area is firmly connected to the face 11 of the membrane 1 after being dried.

Operation 4 can be repeated in order to obtain a greater height of spacing barriers 4.

If necessary, the individual printing operations can be repeated even in more working positions, i.e. the use of two or more screens, and the order of operations can also be reversed.

Upon completion of the printing operations, the membrane is pulled down from the work-bench.

The above-mentioned individual production methods can be modified with regard to different printing devices, for screen printing, flexo printing, offset printing, jet printing, etc., whereas the individual printing operations can be repeated in order to obtain a thicker printing layer.

### Production Method Example 6

### Operation 1

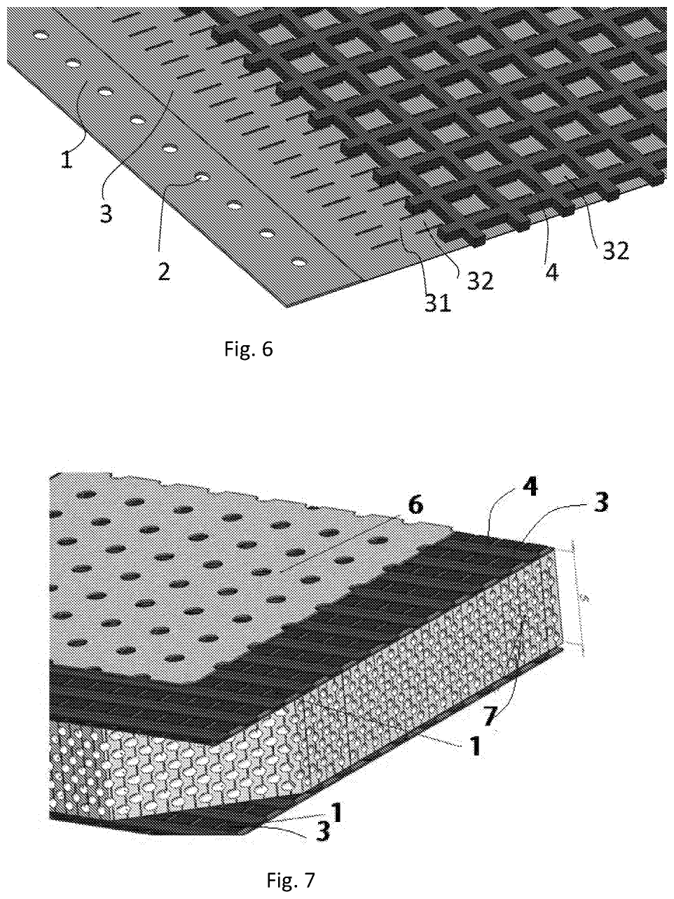

The perforated membrane 1 made of soft PVC with a thickness of 1 mm, with through apertures 2 sized 1 mm in diameter, with a square pitch of 4 mm, is placed on a standard laminating/gluing or welding work-bench. The process can be carried out in pieces or continuously from an endless strip. See FIG. 6.

### Operation 2

Using a feed device, the segments 3, with a thickness of 0.3 mm, made of soft PVC with an admixture of rubber (45%), are placed on the face 11 of the membrane 1 so that their working part 32 overlaps the apertures 2 of the membrane 1.

### Operation 3

Using a feed device, the spacing barrier 4 made of perforated PVC foil, with a thickness of 1 mm, with apertures greater than the working part 32 of the segments 3 is placed on the membrane 1 fitted with segments 3 so that these apertures are centred above the apertures 2 in the membrane 1.

It is also possible to use some printing operations from the previously mentioned printing methods 1 to 5 to print the set of segments 3, on which the set of spacing barriers 4 is printed, which overlaps the set of segments 3 only in places of the connecting parts 31 of segments 3. In this case, operations 2 and 3 will be combined in one common operation.

### Operation 4

Using a heated lamination roller or a high-frequency planar electrode, the membrane 1 is connected with the segments 3 in the connecting part 31 and the spacing barrier 4 into one whole.

The above method may be reversed or may be combined with the printing technology.

The method of using the one-way permeable membrane in the insole design

1. The method of using a new design arrangement of the insole with the one-way permeable membrane.

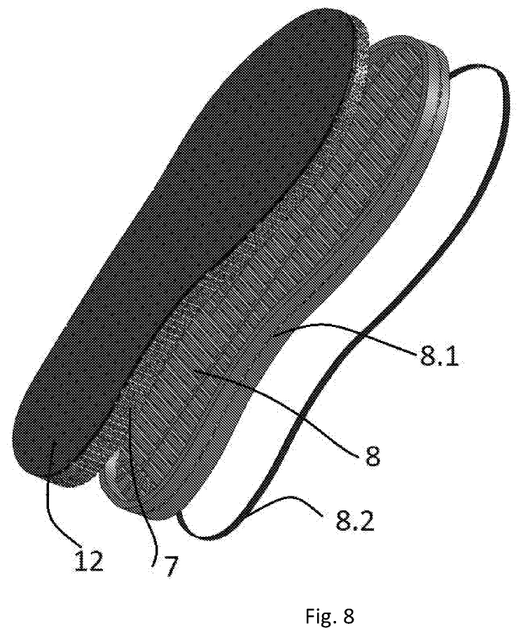

In a standardly prepared footwear insole 7 made of foam material, its tread side is connected, e.g. by gluing, with the spacing barriers 4 on the face 11 of the membrane 1 with apertures into one whole which is subsequently inserted into the skeleton 8 of the shoe with a grooved bottom and ventilation apertures 81 covered by the cover tape 82. See FIG. 8.

2. The method of using a new design arrangement of the insole with the one-way permeable membrane.

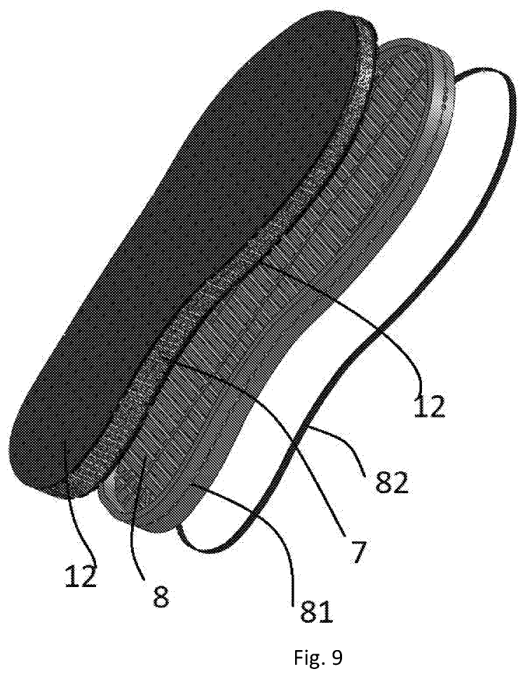

In a standardly prepared footwear insole 7 made of foam material, its tread side is connected, e.g. by gluing, with the spacing barriers 4 with the face 11 of the membrane 1 with apertures, and its lower side is connected, by gluing, with the underside 12 of the membrane 1 into one whole which is subsequently inserted into the skeleton 8 of the shoe with a grooved bottom and ventilation apertures 81 covered by the cover tape 82. The sides can be swapped. See FIG. 7 and FIG. 9.

3. The method of using a new design arrangement of the insole with the one-way permeable membrane.

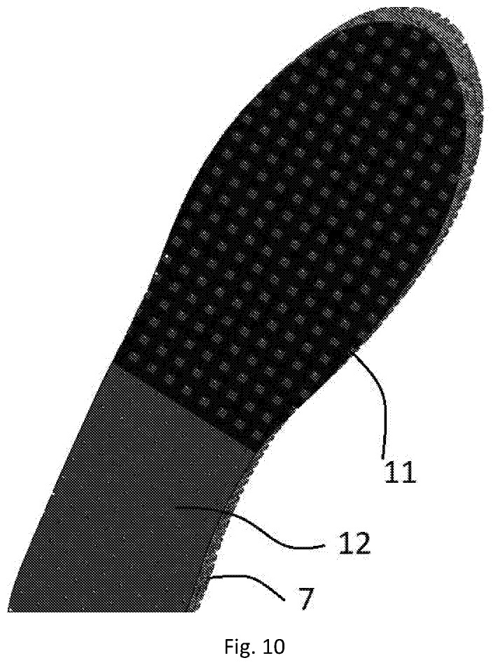

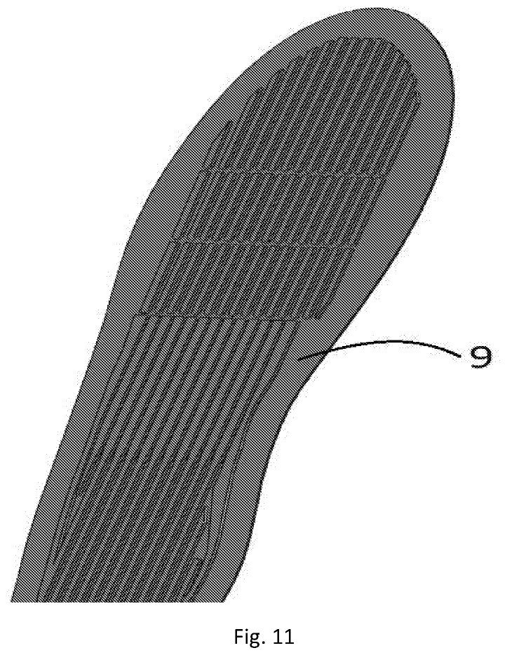

In a standardly prepared footwear insole 7, made of foam material, its upper side in the heel region is connected, by gluing, through the spacing barriers 4, with the face 11 of the membrane 1 with apertures, and its region of toes and metatarsus is connected, by gluing, with the underside 12 of the membrane 1. If the lower side of the insole 7 is backed with the grooved foil 9, the air circulation will be improved. See FIG. 10 and FIG. 11.

### REFERENCES

1 membrane with apertures
11 face layer of the membrane
12 underside layer of the membrane
13 separation layer
14 bonding layer/adhesive bridge
141 connecting apertures
2 apertures
3 segments
31 connecting part of the segments
32 working part of the segments
4 spacing barrier
5 work-bench surface
51 protrusions
6 protective textile
7 insole made of foam material
8 shoe skeleton
81 ventilation apertures in the skeleton
82 protective tape of the ventilation apertures
9 grooved foil

1. A membrane, single-layer or multilayer, with through apertures, wherein thin flexible plastic or rubber segments are attached to its face layer, whereas they overlap the apertures and allow the air or liquid to flow only in the direction from the underside layer of the membrane to the face layer of the membrane, as check valves/flaps in the number of up to 30 pieces per 1 cm2.

2. The plastic or rubber flexible segments according to claim 1, wherein the segments, individual or mutually connected by the connecting parts, are composed of an unfixed working part overlapping the apertures in the membrane and a connecting part firmly attached to the face of the membrane.

3. The membrane according to claim 2 2, wherein spacing barriers made of plastics or rubber are attached to its face layer, whereas they have a height being at least twice greater than the thickness of the segments and bound the surface the face layer of the membrane under the working part of one to four segments.

4. A method for manufacturing the membrane according to claim 2 2, wherein the segments are made of the material adhesive to the material of the face layer of the membrane and, using a standard printing technology (screen printing, flex printing, offset printing, jet printing, etc.), are printed on the face layer of the membrane, but only after the lately removable or releasable partial separation layer is printed on the places under the working part of the segments and apertures, whereas and the connecting parts of the segments are firmly connected with the face of the membrane after drying/curing and the working part of the segments is released after removal or release of the partial separation layer.

5. The method for manufacturing the membrane according to claim 2 2, wherein the segments are made of material non-adhesive to the material of the face layer of the membrane and, using a standard printing technology (screen printing, flexo printing, offset printing, jet printing, etc.), are printed on the face layer of the membrane, but only after the partial bonding layer, made of the material adhesive to the material of the face layer of the membrane as well as the material of the segments, is printed on places under the connecting part of the segments, with which it forms a firm connection after drying, whereas only the working part of the segments will remain free.

6. The method of manufacturing the membrane according to claim 3, wherein the segments are made of material non-adhesive to the material of the face layer of the membrane and, using a standard printing technology (screen printing, flexo printing, offset printing, jet printing, etc.), are printed on the face layer of the membrane, and the spacing barrier of material adhesive at least to the material of the face layer of the membrane is then printed on the connecting parts of the segments and the face layer of the membrane, with which it is firmly connected after drying, overlapping and also retaining the connecting parts of the segments at the face layer of the membrane whereas the working part of the segments is free.

7. The method of manufacturing the membrane according to claim 6, wherein the membrane with through apertures, in the desired shape and thickness, is printed on the work-bench with Teflon or other non-adhesive surface finish which can be permanently fitted with protrusions filling the area of the apertures of the printed membrane so as to achieve a plane for printing the segments or the protrusions are printed from a material similar to the material for the separation layer, always before or after the printing of the membrane, the protrusions are removed after all priming operations are completed.

8. The method of manufacturing the membrane according to claim 6, wherein the membrane with through apertures is a pre-fabricated perforated foil or fabric which is fed from a roll into a standard printing machine, in which it is printed with the partial separation layer on the face of the membrane, whereas the segments are printed afterwards and their connecting parts are joined to the face layer of the membrane, and whereas the face of the membrane is printed with spacing barriers which, after thermal drying, also firmly adhere to the face layer of the membrane, whereas the working part of the segments will get loose after the separation layer is removed.

9. The method of manufacturing the membrane according to claim 3, wherein the segments are made of material adhesive only to the material of the bonding layer and, using a standard printing technology (screen priming, flexo printing, offset printing, jet printing, etc.), on the work-bench with Teflon or other non-adhesive surface finish, the partial bonding layer is printed first, forming a set of a plurality of individual discrete elements of the size and location allowing for a partial overlap of the partial bonding layer with the membrane during the subsequent printing of the membrane with through apertures, in the places of the connecting apertures in the membrane, and subsequent connection of the partial bonding layer with the segments through the connecting apertures by means of the connecting parts of the segments printed on the face of the membrane.

10. The method of manufacturing the membrane according to claim 9 wherein the freedom of movement of the working part of the segments above the apertures in the membrane is ensured by the fact that the separation layer, e.g. a solution of K2CO3 (50%), glucose (25%) and water (25%) with a low addition of surfactant or oil emulsion, is printed before printing the segment, on the area of the face layer of the membrane under the working part of the segment, forming a mechanical or chemical barrier against the connection of the material of the working part of the segment printed on the face of the membrane prior to its drying/curing, whereas the separation layer is removed or eliminated after the end of the production cycle.

11. The method of manufacturing the membrane according to claim 9, wherein the freedom of movement of the working part of the segments above the apertures in the membrane is ensured by the fact that the printing of the segments is done with a material, e.g. based on a silicone emulsion, which is non-adhesive to the material of the face of the membrane, e.g. made of PVC and rubber mixtures, even in the uncured state, whereas—after curing—the working part of the segments remains free and the connecting part of the segments is attached to the membrane, e.g. mechanically by reprinting the spacing barriers.

12. The method of manufacturing the membrane according to claim 3, wherein the membrane with through apertures placed on the laminating or welding work-bench is a pre-fabricated perforated foil whose through apertures are, by means of a feed device, overlapped from the face with the working parts of the segments made of flexible plastic or robber, and the feed device is then used to lay the spacing barrier formed by a perforated foil whose apertures are larger than the size of the working part of the segments above which they are positioned, whereas they are connected to each other in this position by heat lamination/gluing or high-frequency welding.

13. The method of manufacturing the membrane according to claim 3, wherein the set of segments using a standard printing technology (screen printing, flex printing, offset printing, jet printing, etc.), is printed on a non-adhesive work surface and then overprinted by a set of spacing barriers, with which it is connected at the places of the connecting parts, whereas this assembly—after removal from the work surface—is connected to the perforated membrane by heat lamination, gluing or high frequency welding so that the working parts of the segments overlap the apertures in the membrane with which the connecting parts of the segments are connected.

14. The method of using the membrane according to claim 3, wherein the standard insole of the foam material, from its tread side, is at least partly covered by the membrane which ensures air flow only in one direction.

15. The method of using the membrane according to claim 3, wherein the standard insole of the foam material, from its tread as well as lower side, is at least partly covered by the membrane which ensures air flow only in one direction.

16. Method for using the membrane according to claim 3, wherein the standard insole of the foam material, from its tread side in the heel region, is covered by the face part of the membrane, and, in the region of toes and metatarsus, is covered by the underside part of the membrane which provides air circulation.
